(19) United States
(12) Patent Application Publication
(10) Pub. No.: US 2025/0165972 A1
(43) Pub. Date: May 22, 2025

(54) FRAUD PREVENTION PARALLEL METAVERSE SYSTEM

(71) Applicant: Bank of America Corporation, Charlotte, NC (US)

(72) Inventor: Saurabh Gupta, New Delhi (IN)

(21) Appl. No.: 18/510,773

(22) Filed: Nov. 16, 2023

(51) Int. Cl. G06Q 20/40; G06Q 20/22

(52) U.S. Cl. CPC G06Q 20/4014; G06Q 20/223; G06Q 20/4016

(57) ABSTRACT

Provided herein is a system. The system may include a parallel metaverse creator layer. The system may include a parallel metaverse verifier layer. The system may include a data sharing interface. The system may include a data deciphering interface. The system may include an NFT stacker. The system may include an NFT validator. The system may include a payment decision interface. the system may include a transaction decision interface. The system may include a payment initiator interface. The system may include a transaction initiator interface.

.

### FIELD OF TECHNOLOGY

Aspects of the disclosure relate to methods for preventing fraudulent transactions and enable monitoring of transactions in metaverses.

### BACKGROUND

A metaverse may be understood as a network of real-time rendered 3D virtual worlds that can be experienced synchronously and persistently by multiple users with an individual sense of presence and with continuity of data. Individual users may each have their own identity, history, entitlements, objects, communications, and payments. A metaverse may include “digital” or “virtual” spaces that emulate or expand upon the physical world. The spaces may be accessible via a PC or virtual reality (VR) headset. Virtual spaces may include synchronous events occurring in real-time for users.

A metaverse may enable purchases of virtual items. Such purchases may utilize cryptocurrencies.

It would be advantageous to have systems and methods for real-time monitoring of asset transfers and transactions in the metaverse.

It would be further desirable to have methods of preventing fraudulent metaverse transactions and halting in real time suspicious attempted transactions in metaverses.

### SUMMARY

It is an object of this invention to improve the security of metaverse transactions.

It is a further object of this invention to provide a system for enabling real-time scrutiny of attempted asset transfers in the metaverse.

A method in accordance with the principles of the described embodiments may be implemented by a computer and/or be automated.

A method in accordance with the principles of the described embodiments may utilize a computer processor and one or more non-transitory computer-readable media storing computer executable instructions. The instructions, when executed by the computer processor, may automatically create a parallel metaverse, scrutinize a suspicious transaction attempt, and/or perform various other activities, as described herein.

Provided herein is a method of transferring an asset, in accordance with the principles of the described embodiments. The transfer may be a transaction. The method may be a method of performing a transaction. The attempted transfer may be from one user to another user of an existing metaverse. The payor and recipient users may be referred to herein as the “first” and “second” users, respectively. The attempted transfer may be from one avatar to another in an existing metaverse. The payor and recipient avatars may be referred to herein as the “first” and “second” avatars, respectively. The metaverse may exist prior to commencing the described methods. The preexisting metaverse may be referred to herein as an “existing metaverse”.

The described method may include the step of detecting a suspicious characteristic of an attempted transfer or transaction or the environment of the transfer or transaction. The suspicious characteristic may be a characteristic of the first user or avatar. The suspicious characteristic may be a characteristic of the second user or avatar. The suspicious characteristic may be a characteristic of the metaverse. The suspicious characteristic may be any other characteristic. The suspicious characteristic may be detected using standard banking protocols. The banking protocols may be protocols known in the art. The protocols may be specific to transactions performed in a metaverse.

The described method may include the step of freezing the described attempted asset transfer. The attempted transfer may be a suspicious transaction attempt, for example as described hereinabove. The freeze may be implemented when the transfer is attempted. The freeze may be implemented when a suspicious characteristic is detected. The freeze may be implemented in real time. In some embodiments, the freeze may serve to at least temporarily halt the transaction. The transaction may be subsequently allowed in the existing metaverse, following approval of the transaction in the parallel metaverse. In some embodiments, the freeze may permanently disable the transaction. The transaction may need to be initiated de novo in the existing metaverse, following approval of the transaction in the parallel metaverse.

The described method may include the step of creating a parallel metaverse. The parallel metaverse may be created when the transfer is attempted. The parallel metaverse may be created when a suspicious characteristic is detected. The parallel metaverse may be created in real time following the transfer attempt. The parallel metaverse may be created in real time upon detecting the suspicious characteristic.

The term “real time”, as used herein, may refer to an event occurring within 60 seconds of a described impetus. In some embodiments, the term may refer to an event occurring within 30 seconds of an impetus. In some embodiments, the term may refer to an event occurring within 15 seconds of an impetus. In some embodiments, the impetus is the detection of a suspicious transaction attempt.

The described parallel metaverse may include an interface. The interface may enable users to interact with the parallel metaverse. The users may be represented in the metaverse by first and second avatars. The users may utilize at least some of the same methods to interact with the parallel universe as the existing metaverse. In some embodiments, a user may interact with the parallel metaverse using a device selected from the group consisting of a personal computer, a mobile computing device, a virtual reality headset, and a haptic device. The haptic device may be selected from the group consisting of one or more gloves, a vest, and a tracking suit. The tracking suit may be a full-body tracking suit.

In some embodiments, avatars may be able to interact with the parallel metaverse using the same methods as with the existing metaverse. In some embodiments, avatars may be able to make purchases in the parallel metaverse using the same methods as with the existing metaverse. In some embodiments, avatars may be able to receive payment in the parallel metaverse using the same methods as with the existing metaverse. In some embodiments, the parallel universe may utilize a cryptocurrency. In some embodiments, the cryptocurrency may be selected from the group consisting of Ethereum®, SAND (for example, in use with the metaverse platform The Sandbox™), and MANA (for example, for use with the Decentraland® platform).

In some embodiments, the parallel metaverse may enable at least one of the first and second users to request the described transfer. In some embodiments, the parallel metaverse may enable at least one of the first and second avatars to request the transfer.

It will be appreciated by those skilled in the art that a real-life user may be represented, in a metaverse, by an avatar. The term “avatar” may refer to a manifestation of a user within a metaverse. The look of an avatar may be controllable by a user. An avatar may be able to perform actions within the metaverse. Such actions may include transferring assets and making digital purchases. Such transfers and purchases may utilize a cryptocurrency.

Reference herein to an avatar having authority to perform an action in a metaverse may, in some embodiments, reflect the authority of the person represented by the avatar to perform the action.

In some embodiments, the parallel metaverse may not grant either the first or second user authority to approve the described transfer. In some embodiments, neither of the first and second avatars has authority to approve the transfer.

The described method may include the step of receiving encrypted non-fungible tokens (NFTs) from the existing metaverse. The encrypted NFTs may be in the name of the first user. The encrypted NFTs may be in the name of the second user. The encrypted NFTs may be connected with the first user or avatar. The encrypted NFTs may be connected with the second user or avatar. The encrypted NFTs may be connected with the attempted transfer.

The described method may include the step of converting data received by the existing metaverse. The data may be received in connection with the transfer. The data may be converted into NFTs. The data may be received by the existing metaverse. The data may be received from at least one of the first and second users. The data may be received from at least one of the first and second avatars. The NFTs may be encrypted.

The described method may include the step of transferring one or more NFTs from the existing metaverse to the parallel metaverse. In some embodiments, one or more specific entities may have sole authority to transfer the NFTs. In some embodiments, one or more of the entities may be an organization that manages the existing metaverse. In some embodiments, the organization may be a financial institution. In some embodiments, the organization may be a bank. The NFTs may be encrypted.

In some embodiments, the one or more specific entities in the parallel metaverse may have sole authority to receive the NFTs. In some embodiments, one or more of the entities may be an organization that manages the existing metaverse. In some embodiments, the organization may be a financial institution. In some embodiments, the organization may be a bank.

The described method may include the step of decrypting the NFTs. In some embodiments, the NFTs may be decrypted by a processor in the parallel metaverse.

The described method may include the step of receiving a determination of whether to approve the requested transfer. The determination may be made by a processor in the parallel metaverse. The determination may be made by a party in the parallel metaverse. The party may be a financial institution. In some embodiments, the party authorized to approve the transfer may be a party other than the first and second users. In some embodiments, the party authorized to approve the transfer may be a party other than the first and second avatars. In some embodiments, the first and second users may lack authority to approve the transfer in the parallel metaverse. In some embodiments, the first and second avatars may lack authority to approve the transfer in the parallel metaverse.

In some embodiments of the described systems and methods, the party authorized to approve a transfer or transaction is a financial institution. In some embodiments, the financial institution is a bank. In some embodiments, the financial institution or bank is used by the existing metaverse to effect transactions. In some embodiments, the financial institution or bank has an organizational role in the existing metaverse. In some embodiments, the parallel metaverse includes an infrastructure for the financial institution or bank to perform transactions.

The described method may include the step of performing the requested transfer. The method may include the step of transferring the asset from the first user to the second user. The method may include the step of transferring the asset from the first avatar to the second avatar. In some embodiments, the transfer may only be effected after the transfer is approved. In some embodiments, the approval may be from a party mentioned hereinabove. In some embodiments, the transfer may occur in the parallel metaverse. In some embodiments, the transfer may occur in the existing metaverse.

The herein-described methods may include the step of temporarily deactivating one or more financial institutions of the existing metaverse. The described methods may include the step of freezing the activities of one or more financial institutions of the existing metaverse. The activities may be suspended specifically for the attempted transaction. The activities may be suspended generally.

The herein-described methods may include the step of temporarily deactivating the interface between the existing metaverse and the parallel metaverse.

As used herein, the term “metaverse” may refer to a network of real-time rendered 3D virtual worlds that can be experienced synchronously and persistently by multiple users with an individual sense of presence and with continuity of data. Individual users may each have their own identity, history, entitlements, objects, communications, and payments. A metaverse may include “digital” or “virtual” spaces that emulate or expand upon the physical world. The spaces may be accessible via a computing device or virtual reality (VR) headset. Virtual spaces may include synchronous events occurring in real-time for users.

The described metaverse may utilize a VR or augmented reality (AR) device. The term “virtual reality” or “VR” may refer to a simulated 3D environment enabling users to interact with virtual surroundings similar to reality perception through human senses. This approximation of reality may be accessed, for example, through a VR headset that occupies a user's field of vision. VR may utilize one or more haptic devices. The term “haptics” may refer to a technology that creates a touch experience by applying forces, vibrations, and/or motions. Haptic devices may include gloves, vests, and full-body tracking suits.

The term “augmented reality” may refer to a digital overlay on top of the real world. Users may be able to interact with their real-world environment.

The described metaverse may utilize digital twins. The term “digital twin” may refer to a system including: (a) a physical object or process and its physical environment; (b) a digital representation of the object or process; and (c) a communication channel between the physical and virtual representations.

The described metaverse may utilize blockchain technology. The term “blockchain” may refer to a type of distributed ledger technology. A distributed ledger is a database that is consensually shared among multiple users and synchronized across multiple sites, institutions, or geographies. A blockchain-based currency may be used to purchase items in the metaverse. The blockchain may be used to publicly record transactions on a digital ledger and thus substantiate who owns the purchased item.

The term “tokenization” may refer to the process of issuing a digital representation of an asset on a blockchain.

The term “blockchain address” may refer to a unique identifier enabling a user to send and receive a digital asset. A blockchain address may be analogous to a bank account for standard currency. A blockchain address may consist of a fixed number of alphanumeric characters generated from a pair of a public key and a private key.

The term “non-fungible token” or “NFT” may refer to a unique digital asset that is stored on a blockchain and cannot be duplicated or cloned. An NFT may represent an item that was purchased. The item may have been purchased with cryptocurrency. The item may be selected from a photo, music file, video file, collectible digital character, plot of virtual real estate, and an original social media post. An NFT may be non-interchangeable with any other NFT. The term “fungible” may refer to an item of such a nature that another equal part or quantity may replace one part or quantity in paying a debt or settling an account. Money and commodities may be non-limiting examples of fungible assets.

In some embodiments, the establishment of an NFT may include the following five steps:
1) NFT Digitizing. The NFT owner checks the accuracy of the file, title, and description. Then the owner digitizes the raw data into a proper format.
2) NFT Storage. The NFT owner stores the raw data in an external database outside the blockchain. Alternatively, the owner can store the raw data inside the blockchain.
3) NFT Signature. The NFT owner signs a transaction, including the hash of NFT data, and then sends the transaction to a smart contract.
4) NFT Minting & Trade. After the smart contract receives the transaction with the NFT data, the minting and trading process begins.
5) NFT Confirmation. Confirmation completes the minting process, after which the NFT forever links to a unique blockchain address as its persistence evidence.

The described metaverse may utilize a cryptocurrency to effect purchases. The term “cryptocurrency” may refer to currency in the form of a token written on a blockchain (or tokenized). Two or more cryptocurrencies from the same blockchain may be interchangeable (as opposed to NFTs, which are not fungible)

The described metaverse may utilize a single central cryptocurrency. Use of a central cryptocurrency may enable various other cryptocurrency denominations to be used virtually seamlessly. The metaverse may utilize self-executing smart contracts.

The term “smart contract” may refer to a digital agreement that enables unfamiliar parties and decentralized participants to conduct fair exchanges without a trusted third party. A smart contract may include standardized contractual clauses. These clauses may be embedded in the software used to manage the smart contracts. The smart contracts may enable automatic recording and verification of transactions in the metaverse.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with the principles of the described embodiments.

FIG. 2 shows an illustrative system in accordance with the principles of the described embodiments.

FIG. 3 is a schematic depiction of a system.

FIG. 4 is a schematic depiction of a system.

FIG. 5 is a diagram of a platform for evaluating suspicious metaverse transfers.

FIG. 6 is a flow chart of an exemplary process.

### DETAILED DESCRIPTION

Systems and methods are described for leveraging processors and/or other complex, specific-use computer systems to provide a novel approach for monitoring metaverse transactions.

A method in accordance with the principles of the described embodiments may be implemented by a computer and/or be automated.

A method in accordance with the principles of the described embodiments may utilize a computer processor and one or more non-transitory computer-readable media storing computer executable instructions. The instructions, when executed by the computer processor, may automatically create a parallel metaverse and scrutinize a suspicious asset transfer attempt in the parallel metaverse.

Provided herein is a method of transferring an asset, in accordance with the principles of the described embodiments. The transfer may be a transaction. The method may be for performing a transaction. The metaverse may exist prior to commencing the described methods. The preexisting metaverse may be referred to herein as an “existing metaverse”.

The described method may include the step of detecting a suspicious characteristic of an attempted transfer or transaction or the environment of the transfer or transaction. The suspicious characteristic may be a characteristic of the first user or avatar. The suspicious characteristic may be a characteristic of the second user or avatar. The suspicious characteristic may be a characteristic of the metaverse. The characteristic may be a transaction that deviates from a user's typical behavior pattern, for example in its amount or the type of merchandise purchased. The characteristic may be a repetitive instruction. The characteristic may be a request to urgently transfer an asset, without an explanation given for the urgency. The suspicious characteristic may be any other characteristic. The suspicious characteristic may be detected using standard banking protocols. The banking protocols may be protocols known in the art. The protocols may be specific for transactions performed in a metaverse.

The described method may include the step of suspending the described attempted asset transfer. The attempted transfer may be a suspicious attempt, for example as described hereinabove. The suspension may be implemented when the transfer is attempted. The suspension may be implemented when a suspicious characteristic is detected. The suspension may be implemented in real time. In some embodiments, the suspension may serve to at least temporarily halt the transaction. The transaction may be subsequently restored if the transaction is approved in the parallel metaverse. In some embodiments, the suspension may permanently disable the transaction. The transaction may need to be initiated de novo if the transaction is approved in the parallel metaverse.

The described method may include the step of creating a parallel metaverse. The parallel metaverse may be created when the transfer is attempted. The parallel metaverse may be created when a suspicious characteristic is detected. The parallel metaverse may be created in real time upon detecting the suspicious characteristic. The parallel metaverse may be created in real time.

The described parallel metaverse may include an interface. The interface may enable users to interact with the parallel metaverse. The users may be represented in the metaverse by the first and second avatars. The users may utilize the same methods to interact with the parallel universe as with the existing metaverse. In some embodiments, a user may interact with the parallel metaverse using a device selected from the group consisting of a personal computer, a mobile computing device, a virtual reality headset, and a haptic device. The haptic device may be selected from the group consisting of one or more gloves, a vest, and a tracking suit. The tracking suit may be a full-body tracking suit.

In some embodiments, avatars may be able to interact with the parallel metaverse using the same methods as with the existing metaverse. In some embodiments, avatars may be able to make purchases in the parallel metaverse using the same methods as with the existing metaverse. In some embodiments, avatars may be able to receive payment in the parallel metaverse using the same methods as with the existing metaverse. In some embodiments, the parallel universe may utilize a cryptocurrency.

In some embodiments, the parallel metaverse may differ from the existing metaverse in that avatars in the parallel metaverse do not have authority to authorize a transaction or transfer to an asset. In some embodiments, the parallel metaverse may be able to halt a suspicious transaction before it is consummated, which may not be possible in the existing metaverse. In some embodiments, the parallel metaverse may be able to prevent a fraudulent transaction, which may not be possible in the existing metaverse.

In some embodiments, at least one of the first and second users may have the authority to request the described transfer in the parallel metaverse. In some embodiments, at least one of the first and second avatars may have the authority to request the transfer in the parallel metaverse.

In some embodiments, it may be that neither of the first and second users has authority to approve the described transfer in the parallel metaverse. In some embodiments, it may be that neither of the first and second avatars has authority to approve the described transfer in the parallel metaverse.

The described method may include the step of receiving encrypted NFTs from the existing metaverse. The encrypted NFTs may be owned by the first user. The encrypted NFTs may be owned by the second user. The encrypted NFTs may be owned by the first or second avatar. The encrypted NFTs may be connected with the first user or avatar. The encrypted NFTs may be connected with the second user or avatar. The encrypted NFTs may be connected with the attempted transfer.

The described method may include the step of converting data received by the existing metaverse. The data may be received in connection with the transfer. The data may be converted into NFTs. The data may be received by the existing metaverse. The data may be received from at least one of the first and second users. The data may be received from at least one of the first and second avatars. The NFTs may be encrypted.

The described method may include the step of transferring the NFTs from the existing metaverse to the parallel metaverse. In some embodiments, one or more specific entities may have sole authority to transfer the NFTs. In some embodiments, one or more of the entities may be an organization that manages the existing metaverse. In some embodiments, the organization may be a financial institution. In some embodiments, the organization may be a bank.

In some embodiments, the aforementioned one or more specific entities in the parallel metaverse may have sole authority to receive the NFTs. In some embodiments, one or more of the entities may be an organization that manages the existing metaverse. In some embodiments, the organization may be a financial institution. In some embodiments, the organization may be a bank.

The described method may include the step of decrypting the encrypted NFTs. In some embodiments, the NFTs may be decrypted by a processor in the parallel metaverse.

The described method may include the step of receiving a determination of whether to approve the requested transfer. The determination may be made by a processor in the parallel metaverse. The determination may be made by a party in the parallel metaverse. The party may be one or more financial institutions. In some embodiments, the party authorized to approve the transfer may be a party other than the first and second users. In some embodiments, the party authorized to approve the transfer may be a party other than the first and second avatars determines. In some embodiments, the first and second users may lack authority to approve the transfer in the parallel metaverse. In some embodiments, the first and second avatars may lack authority to approve the transfer in the parallel metaverse.

In some embodiments, the authorized party conducts an independent verification step to confirm the validity of the transaction or asset transfer. In some embodiments, the verification step is a two-step verification process. In some embodiments, the party only approves the transaction or asset transfer if the verification step is successful. In some embodiments, the party requests a confidence award from a third party. In some embodiments, the party only approves the transaction or asset transfer if the requested confidence award is obtained.

The described method may include the step of performing the requested transfer. The method may include the step of transferring the asset from the first user to the second user. The method may include the step of transferring the asset from the first avatar to the second avatar. In some embodiments, the transfer may only be effected after the transfer is approved. In some embodiments, the approval may be from a party mentioned hereinabove.

In some embodiments, the parallel metaverse may remain functional whenever the existing metaverse is functional. In some embodiments, the ability to create and utilize a described parallel metaverse may remain functional whenever the existing metaverse is functional. In some embodiments, the ability to create and utilize a parallel metaverse may be resilient. In some embodiments, a backup server may be configured to reinforce the ability of the described systems to create and utilize a described parallel metaverse.

In some embodiments, the described existing and parallel metaverses may be connected via a network layer. In some embodiments, the network layer may be a component of a described system.

In some embodiments, a described method may include the step of requesting one or more additional NFTs from one or more past transactions. In some embodiments, the first user may have participated in the past transaction(s). In some embodiments, the second user may have participated in the past transaction(s).

In other aspects, there is provided a system, in accordance with the principles of the described embodiments. In some embodiments, the system may include a computer processor.

In some embodiments, a described processor may refer to a processor that is configured to perform one or more method steps connected with the system or method wherein the processor is mentioned. In some embodiments, the processor may be configured to perform any of the described method steps. In some embodiments, the processor may be configured to perform at least one of the tasks described in association with a layer or processor component. In some embodiments, the processor may be configured to perform any of the tasks described in association with a layer or processor component. A non-limiting list of such tasks may include creating a parallel metaverse, verifying the parallel metaverse, sharing data between the existing and parallel metaverses, deciphering data transferred from the existing metaverse to the parallel metaverse, NFT stacking, NFT validating, rendering a payment or transaction decision, and initiating a payment or transaction. In some embodiments, the system may include a network layer. In some embodiments, the network may enable communication between the existing and parallel metaverses. In some embodiments, the network may enable communication between two or more layers and/or processor components described hereinbelow.

In some embodiments, the system may include a parallel metaverse creator layer. In some embodiments, this layer may be configured to create a parallel metaverse. In some embodiments, the parallel metaverse may have one or more of the characteristics of a parallel metaverse described hereinabove.

In some embodiments, the system may include a parallel metaverse verifier layer. In some embodiments, this layer may be configured to verify a parallel metaverse. In some embodiments, this layer may be configured to validate a parallel metaverse. In some embodiments, this layer may be configured to confirm that a parallel metaverse has one or more characteristics required by a described protocol. In some embodiments, the characteristics may be shared with an existing metaverse.

In some embodiments, the system may include a data sharing interface. In some embodiments, this interface or component may be configured to enable transfer of data from the existing metaverse to the parallel metaverse. In some embodiments, this interface or component may be configured to enable transfer of data from the parallel metaverse to the existing metaverse. In some embodiments, this interface or component may be configured to enable transfer of data between the existing metaverse and the parallel metaverse.

In some embodiments, the system may include a data deciphering interface. In some embodiments, this interface or component may be configured to decipher data transferred from the existing metaverse to the parallel metaverse. In some embodiments, the data may be in the form of NFTs.

In some embodiments, the system may include an NFT stacker. In some embodiments, the system may include an NFT staker. In some embodiments, this layer or component may be configured to present NFTs to an NFT validator. In some embodiments, this layer or component may be configured to process and prepare data packets from individual NFTs, to facilitate inspection of the data packets by a validator. In some embodiments, this layer or component may be configured to verify the credit history of an avatar. In some embodiments, this layer or component may be configured to present one or more confidence awards in connection with the first or second user. In some embodiments, this layer or component may be configured to present one or more confidence awards in connection with the first or second avatar. In some embodiments, the confidence award(s) may be provided by one or more users in the existing metaverse other than the first and second user. In some embodiments, the confidence award(s) may be provided by one or more avatars in the existing metaverse other than the first and second avatar.

In some embodiments, the system may include an NFT validator. In some embodiments, this component may be configured to validate at least one NFT. In some embodiments, this component may be configured to verify at least one NFT. In some embodiments, this component may be configured to verify the integrity of an NFT(s). In some embodiments, this component may be configured to verify that an NFT(s) is untampered.

In some embodiments, the system may include a payment decision interface. In some embodiments, the system may include a transaction decision interface. In some embodiments, this interface or component may be configured to integrate information received from the existing metaverse and determine whether the attempted transaction is trustworthy. In some embodiments, the information received may include data selected from one or more NFTs and credit history information. In some embodiments, this interface or component may be configured to determine whether the avatars participating in the attempted transaction are trustworthy. In some embodiments, this interface or component may be configured to determine whether the participating users are trustworthy. In some embodiments, an avatar may be deemed trustworthy if it presents a confidence award that has been previously validated by a third party. In some embodiments, an avatar may be deemed trustworthy if it passes a banking verification procedure. The verification procedure may be provision of personal information such as a debit card number or a portion thereof, an account number or a portion thereof, or the amount of a recent transaction.

In some embodiments, the system may include a payment initiator interface. In some embodiments, the system may include a transaction initiator interface. In some embodiments, this interface or component may be configured to communicate with the sender bank. In some embodiments, this component may be configured to communicate with the sender bank integrator (see below). In some embodiments, this component may be configured to communicate with the receiver bank. In some embodiments, this component may be configured to communicate with the receiver bank integrator (see below). In some embodiments, this component may be configured to transmit instructions to the sender bank, or bank integrator, to initiate a transfer. In some embodiments, this component may be configured to obtain account details from the receiver bank, or bank integrator. In some embodiments, this component may be configured to provide account details to the sender bank, or bank integrator.

In some embodiments, the described system may optionally include a sender bank integrator. In some embodiments, the integrator may be configured to facilitate communication between the parallel metaverse and the sender bank.

In some embodiments, the described system may optionally include a receiver bank integrator. In some embodiments, the integrator may be configured to facilitate communication between the parallel metaverse and the receiver bank.

In some embodiments, the described system may optionally include a payer credit history controller. In some embodiments, the controller may be configured to request and receive credit history information from the sender bank. In some embodiments, the controller may be configured to request and receive credit history information from a financial institution or bank used by the first user to conduct transactions in the existing metaverse. In some embodiments, the controller may be configured to request and receive information from the parallel metaverse verifier.

In some embodiments, the payer credit history controller may be configured to request one or more NFTs from a past transaction. In some embodiments, the payer credit history controller may be configured to request a confidence award from one or more other avatars. In some embodiments, the payer credit history controller may be configured to request a confidence award from one or more other users of the existing metaverse. In some embodiments, the other user(s) may have performed transactions with the first user. In some embodiments, the other user(s) may have performed transactions with the second user.

In some embodiments, the described system may optionally include an optional role assignment interface. In some embodiments, the role assignment interface may be configured to assign a role to the described NFT stacker. In some embodiments, the role assignment interface may be configured to assign a role to the described NFT validator. In some embodiments, the role assignment interface may be configured to assign a role to the described parallel instance maintenance layer (see hereinbelow). In some embodiments, the role(s) assigned by the role assignment interface may be a role described herein.

In some embodiments, the described system may optionally include a parallel instance maintenance layer. In some embodiments, this layer may be configured to enable the parallel metaverse to function in a similar manner to the existing metaverse. In some embodiments, this layer may enable the parallel metaverse to reflect the functionality of the existing metaverse. In some embodiments, this layer may facilitate communication between the existing and parallel metaverses.

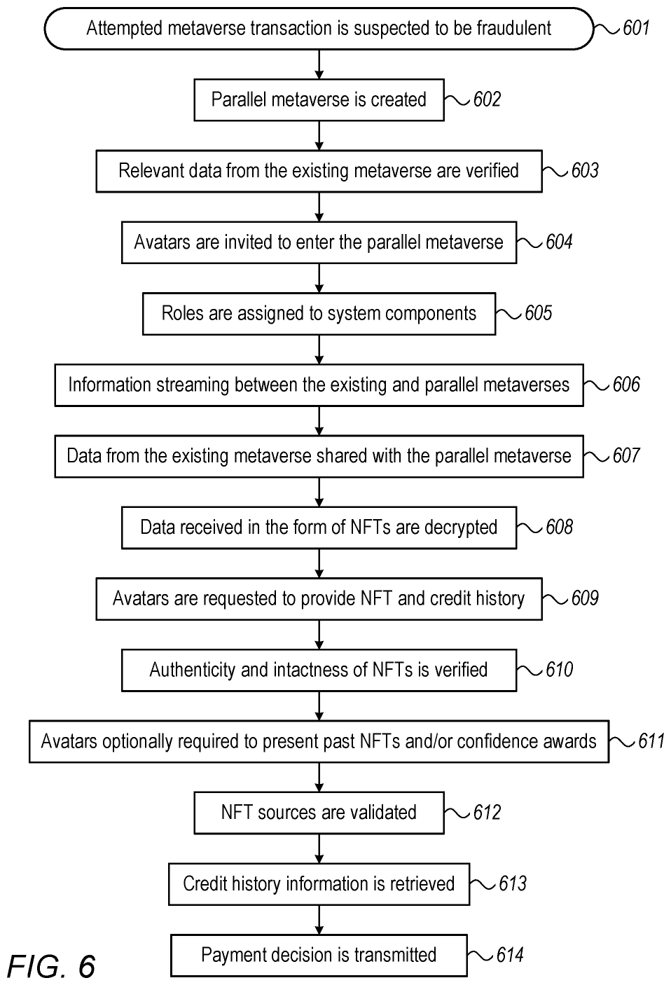

In some embodiments, the described system may be configured to perform a method including one or more of the steps set forth in the description of FIG. 6 hereinbelow:

Each of the aforementioned steps may represent a separate embodiment. Each combination of steps may represent a separate embodiment.

In other aspects, there is provided a method, in accordance with the principles of the described embodiments. In some embodiments, the method may utilize a computer processor. The metaverse may exist prior to commencing the described methods. The preexisting metaverse may be referred to herein as an “existing metaverse”. The transfer may be from one user to another in a metaverse. The transfer may be from one avatar to another in a metaverse.

The described method may include the step of detecting a suspicious characteristic of an attempted transfer or transaction. The suspicious characteristic may relate to the manner of functioning of the metaverse. The suspicious characteristic may be a characteristic of the first user or avatar. The characteristic may be a characteristic of the second user or avatar. The characteristic may be a characteristic of the metaverse. The suspicious characteristic may be any other characteristic. The suspicious characteristic may be detected using standard banking protocols. The banking protocols may be protocols known in the art. The protocols may be specific for transactions performed in a metaverse.

The described method may include the step of suspending the described attempted asset transfer. The attempted transfer may be a suspicious attempt, for example as described hereinabove. The suspension may be implemented when the transfer is attempted. The suspension may be implemented when a suspicious characteristic is detected. The suspension may be implemented in real time. In some embodiments, the suspension may serve to at least temporarily halt the transaction. The transaction may be subsequently reinstated if the transaction is approved in the parallel metaverse. In some embodiments, the suspension may permanently disable the transaction. The transaction may need to be initiated de novo if the transaction is approved in the parallel metaverse.

The described method may include the step of creating a parallel metaverse. The parallel metaverse may be created in real time. The parallel metaverse may be created when the transfer is attempted. The parallel metaverse may be created when a suspicious characteristic is detected. The parallel metaverse may be created in real time upon one of the aforementioned triggering events.

The described parallel metaverse may include an interface. The interface may enable users to interact with the parallel metaverse. The users may be represented in the metaverse by the first and second avatars. The users may utilize the same methods to interact with the parallel universe as with the existing metaverse. In some embodiments, a user may interact with the parallel metaverse using a device selected from the group consisting of a personal computer, a mobile computing device, a virtual reality headset, and a haptic device. The haptic device may be selected from the group consisting of one or more gloves, a vest, and a tracking suit. The tracking suit may be a full-body tracking suit.

In some embodiments, avatars may be able to interact with the parallel metaverse using the same methods as with the existing metaverse. In some embodiments, avatars may be able to make purchases in the parallel metaverse using the same methods as with the existing metaverse. In some embodiments, avatars may be able to receive payment in the parallel metaverse using the same methods as with the existing metaverse. In some embodiments, the parallel universe may utilize a cryptocurrency.

In some embodiments, at least one of the first and second users may have the authority to request the described transfer in the parallel metaverse. In some embodiments, at least one of the first and second avatars may have the authority to request the transfer in the parallel metaverse.

In some embodiments, the parallel metaverse may not enable either of the first and second users to approve the described transfer in. In some embodiments, neither of the first and second avatars may have authority to approve the described transfer in the parallel metaverse.

The described method may include the step of receiving encrypted NFTs from the existing metaverse. The encrypted NFTs may be in the name of the first user. The encrypted NFTs may be in the name of the second user. The encrypted NFTs may be connected with the first user or avatar. The encrypted NFTs may be connected with the second user or avatar. The encrypted NFTs may be connected with the attempted transfer.

The described method may include the step of converting data received by the parallel metaverse. The data may be received in connection with the transfer. The data may be converted into NFTs. The data may be received from the existing metaverse. The data may be received from at least one of the first and second users. The data may be received from at least one of the first and second avatars. The NFTs may be encrypted.

The described method may include the step of transferring NFTs from the existing metaverse to the parallel metaverse. In some embodiments, one or more specific entities may have sole authority to transfer the NFTs. In some embodiments, one or more of the entities may be an organization that manages the existing metaverse. In some embodiments, the organization may be a financial institution. In some embodiments, the organization may be a bank. In some embodiments, the one or more specific entities may have sole authority to receive the NFTs in the parallel metaverse.

The described method may include the step of decrypting encrypted NFTs. In some embodiments, the NFTs may be decrypted by a processor in the parallel metaverse.

The described method may include the step of receiving a determination of whether to approve the requested transfer. The determination may be made by a processor in the parallel metaverse. The determination may be made by a party in the parallel metaverse. The party may be one or more financial institutions. In some embodiments, the party authorized to approve the transfer may be a party other than the first and second users. The party authorized to approve the transfer may be a party other than the first and second avatars. In some embodiments, the first and second users may lack authority to approve the transfer. In some embodiments, the first and second avatars may lack authority to approve the transfer.

In some embodiments, the described method may include the optional step of requesting one or more additional NFTs from one or more past transactions. In some embodiments, the first user may have participated in the past transaction(s). In some embodiments, the second user may have participated in the past transaction(s).

In some embodiments, the described method may include the optional step of requesting, from one or more other avatars, a confidence award for the first avatar. In some embodiments, the described method may include the step of requesting, from one or more other avatars, a confidence award for the second avatar. In some embodiments, the confidence award may be requested from one or more users of the existing metaverse. The confidence award may be requested from a financial institution participating in the existing metaverse. The confidence award may be requested from a financial institution utilized by the existing metaverse for transactions. As used herein, the term “confidence award” may refer to a certification that a user has been validated for asset transfers and/or transactions. The term “confidence award” may refer to a certification that a blockchain address is valid.

The described methods may include the optional step of requesting the credit history of the first avatar. The method may include the step of requesting the credit history of the second avatar. The credit history may be supplied by a financial institution participating in the existing metaverse. The credit history may be supplied by a financial institution that manages or helps to manage the existing metaverse. The credit history may be supplied by a financial institution utilized by the existing metaverse for transactions. The credit history may be supplied to a financial institution or bank interacting with the parallel metaverse.

In some embodiments, a financial institution in communication with the described parallel metaverse may research the credit history and/or transaction history of one or more users participating in the attempted transaction. In some embodiments, each user or avatar is requested to provide its credit history and/or transaction history. In some embodiments, the credit history and/or transaction history are provided from a bank in which each user or avatar is a member or customer.

Any of the aforementioned methods may be for preventing a fraudulent asset transfer. The method may be for preventing a fraudulent transaction. The asset may be transferred from one user to another user of an existing metaverse. The payor and recipient users may be referred to herein as the “first” and “second” users, respectively. The asset may be transferred from one avatar to another in an existing metaverse. The payor and recipient avatars may be referred to herein as the “first” and “second” avatars, respectively. The asset transfer may occur in a metaverse.

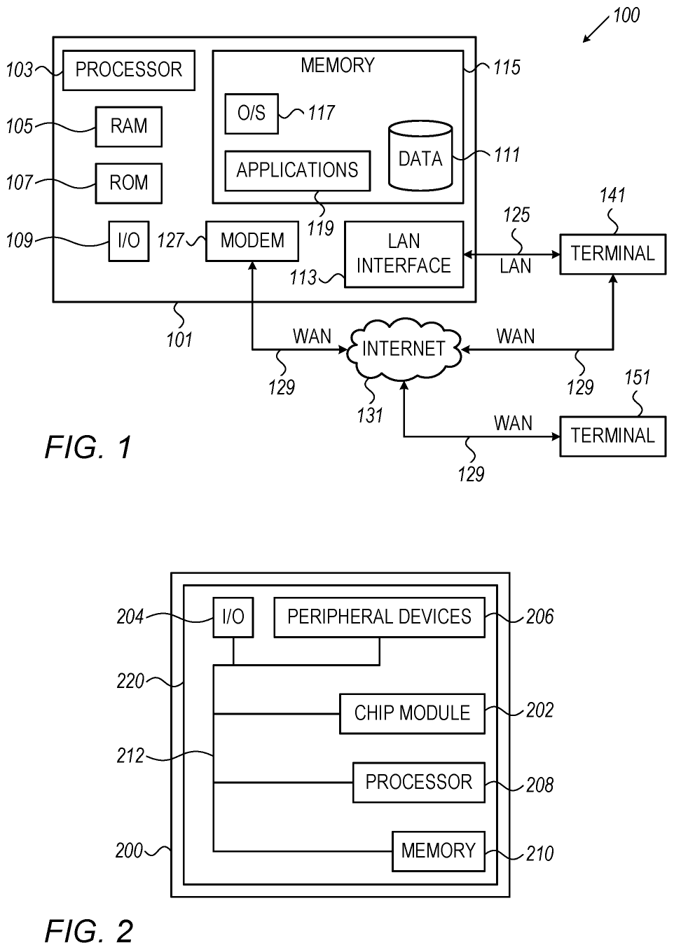

The aforementioned processing device or computer processor may be a computer, as described in more detail in FIG. 1, optionally including any of the components and elements described for FIG. 1.

In some aspects, the processing device or computer processor may be a computer, as described in more detail in FIG. 2, optionally including any of the components and elements described for FIG. 2.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

One or more of the described parallel metaverse, the parallel metaverse creation layer, the parallel metaverse verifying layer, the data sharing interface, and the other layers and components mentioned herein may comprise one or more computer systems and servers that include one or more of the following hardware components: Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology-e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative, and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may implement the methods for creating and utilizing a parallel metaverse as described herein. The computer executable instructions may be embodied in hardware or firmware (not shown). The computer 101 may execute the instructions embodied by the application program(s) 119 to perform various functions, such as creating a parallel metaverse and receiving information from the existing metaverse.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. Such programs may be considered engines for the purposes of this application and with respect to the performance of the particular tasks to which the programs are assigned, for example for creation of a parallel metaverse, receiving and deciphering NFTs and other information from an existing metaverse, determining whether a transaction should be approved, and transmitting instructions to an existing metaverse to fill or cancel an attempted transaction.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

FIG. 2 shows illustrative apparatus 200 that may be configured in accordance with the principles of the described embodiments. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

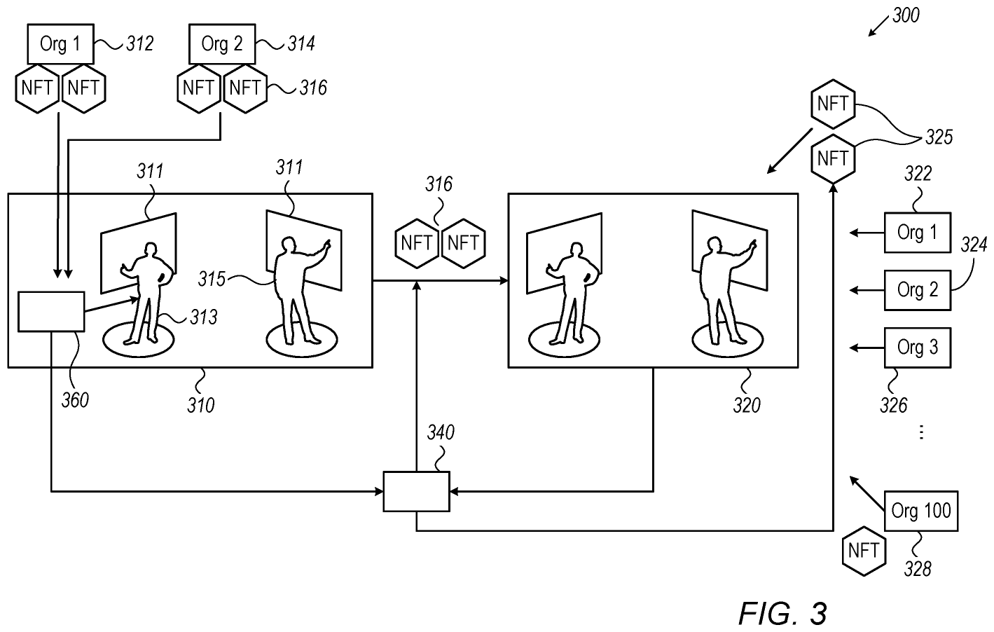

FIG. 3 is a schematic depiction of a system 300, including an existing metaverse 310 and a parallel metaverse 320 that may be created to process transaction request 311 to transfer an asset in metaverse 310, in accordance with the principles of the described embodiments. A plurality of organizations 312, 314 (only two are depicted, for simplicity) in existing metaverse 310 may send data relating to transaction request 311. The data may be in the form of NFTs 316. Sending avatar 313 and/or receiving avatar 315 may have authority to request and approve transaction request 311 in metaverse 310.

With further reference to FIG. 3, when financial institution, money transfer platform, or bank 360 in existing metaverse 310 detects a suspicious aspect of transaction request 311, parallel metaverse 320 may be created in real time. Transaction request 310 may be suspended, while parallel metaverse 320 investigates its authenticity. Plurality of organizations 312, 314, etc., may be replicated in parallel metaverse 320. NFTs 316 may be imported into parallel metaverse 320. Institution, platform, or bank 360 from existing metaverse 310 may be replicated in the parallel metaverse (see description of 322, 324, 326, 328). Bank 360 or organizations 312, 314 may send data relating to transaction request 311 to institution, platform, or bank 340, which may be the same or different from institution, platform, or bank 360. Institution, platform, or bank 340 may operate within the parallel metaverse. Institution, platform, or bank 340 may communicate with institution, platform, or bank 360. Institution, platform, or bank 340 may communicate with a banking entity representing sending avatar 313 in existing metaverse 310.

With further reference to FIG. 3, plurality of parallel metaverse organizations 322, 324, 326, 328 (only four are shown, for simplicity) (which may be replicas of organizations 312, 314, etc.) may send data relating to transaction request 311 to a processor (not shown) configured to evaluate the authenticity of a requested transfer in parallel metaverse 320. Parallel metaverse organizations 322, 324, 326, 328 may be replicas of organizations 312, 314, etc. or may not be replicas of organizations 312, 314, etc. The data may be in the form of NFTs 325, which may have been deciphered by parallel metaverse 320. Institution, platform, or bank 340 may decide whether to approve transaction request 311. The processor may decide whether to approve transaction request 311. The decision may be transmitted to institution, platform, or bank 340.

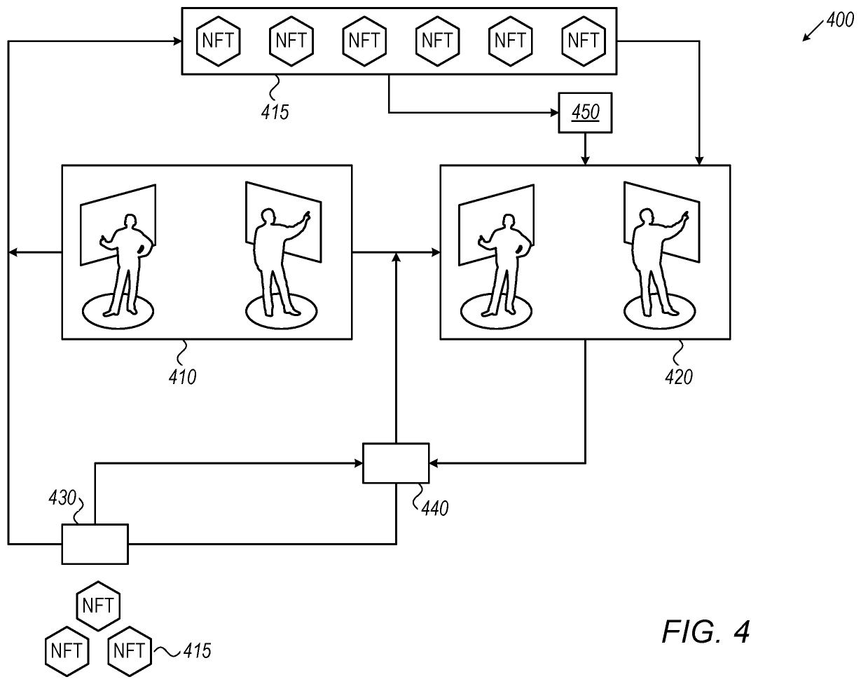

FIG. 4 depicts additional method steps 400 usable with system 300 (see FIG. 3), in accordance with the principles of the described embodiments. Data from existing metaverse 410 may be converted to NFTs 415. The data may be obtained from a financial institution, money transfer platform, or bank 430. The data may be transmitted to parallel metaverse 420. The data may be transmitted to institution, platform, or bank 440, which may be the same or different from institution, platform, or bank 430, or a processor (not shown) configured to evaluate the veracity of attempted transactions. The transfer may occur via network layer 450.

With further reference to FIG. 4, the authority to approve or deny the requested transaction in parallel metaverse 420 may reside with an organization. This organization may be institution, platform, or bank 440; or may be a different institution. This organization may convey a decision to authorize or deny the transfer to institution, platform, or bank 440. If the request is approved, institution, platform, or bank 440 may perform the transfer. If the request is denied, institution, platform, or bank 440 may refuse to perform the transfer. The decision to approve or deny the transfer may be transmitted to an entity in the existing metaverse. The entity may be institution, platform, or bank 430; and/or may be the financial institution or money transfer platform that received the original transfer request in the existing metaverse. The transaction may be blocked from occurring in the original metaverse. The parallel metaverse may be configured to alert the original metaverse to block any future attempts at making the flagged transfer. The parallel metaverse may be configured to alert the original metaverse to block any future attempts at making a transfer similar to the flagged transfer. The term “similar to”, in this regard, may refer to a transfer having the same first avatar (payer/sender), or having the same second avatar (recipient), or otherwise flagged as having similar characteristics to the suspicious transfer.

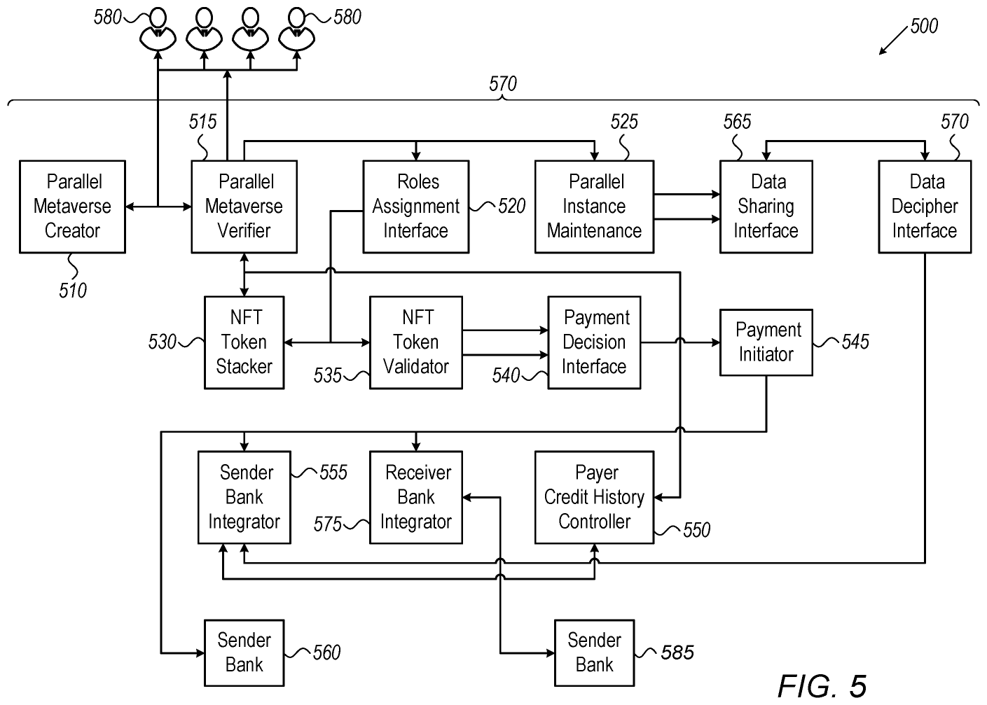

FIG. 5 is a diagram 500 of a platform for evaluating suspicious transfers in an existing metaverse, in accordance with the principles of the described embodiments. Parallel metaverse creator 510 may be configured to receive a notification of a suspicious transfer attempt. Metaverse creator 510 may be configured to create parallel metaverse 570, optionally including avatars 580, and request verification of parallel metaverse 570 from parallel metaverse verifier 515. Metaverse verifier 515 may be configured to verify the integrity of created parallel metaverse 570 and transmit the verification to metaverse creator 510. Metaverse verifier 515 may be configured to verify avatars 580. Metaverse verifier 515 may be configured to transmit a role assignment request to role assignment interface 520. Assignment interface 520 may be configured to activate and/or assign tasks to parallel instance maintenance layer 525, NFT stacker 530, and NFT validator 535.

With further reference to FIG. 5, parallel instance maintenance layer 525 may be configured to activate and/or maintain functionality of data sharing interface layer 565. Data sharing interface layer 565 may be configured to receive data from existing metaverse (not shown) and transmit it to data deciphering interface layer 570.

With further reference to FIG. 5, parallel metaverse verifier 515 may be configured to activate payer credit history controller 550. Payer credit history controller 550 may be configured to request credit history information from sender bank integrator 555. Sender bank integrator 555 may be configured to request credit history information from sender bank 560. Sender bank 560 may be configured to transmit credit history and/or other banking information to sender bank integrator 555. Sender bank integrator 555 may be configured to transmit credit history information to payer credit history controller 550.

With further reference to FIG. 5, data deciphering interface layer 570 may be configured to receive and decipher information from sender bank integrator 555. This information may have been transmitted from sender bank 560 to sender bank integrator 555.

With further reference to FIG. 5, NFT validator 535 may be configured to transmit validated NFT(s) to payment decision interface 540. Payment decision interface 540 may be configured to activate payment initiator 545. Payment initiator 545 may be configured to request and obtain payment account information from receiver bank integrator 575. Receiver bank integrator 575 may be configured to request and obtain payment account information from receiver bank 580.

With further reference to FIG. 5, payment initiator 545 may be configured to instruct sender bank integrator 555 to initiate payment to receiver bank 580. Sender bank integrator 555 may be configured to transmit the payment instructions to sender bank 560. Sender bank 560 may remit payment to receiver bank 580. Payment to sender bank 560 may be processed via sender bank integrator 555 and/or receiver bank integrator 575.

FIG. 6 is a flow chart of an exemplary process, in accordance with the principles of the described embodiments. The process may include one or more of the following steps:

Step 601: An attempted metaverse transaction is suspected of being fraudulent.

Step 602: A parallel metaverse is created. This step may be performed by a parallel metaverse creator layer.

Step 603: Data in the existing metaverse that are relevant to the attempted transaction are verified. This step may be performed by a parallel metaverse verifier layer.

Step 604: The first and second avatars are invited to enter the parallel metaverse.

Step 605: Roles (e.g., speaker, moderator, facilitator, and the like) are assigned to system components. This step may be performed by a role assignment interface or layer.

Step 606: Information streaming is enabled or facilitated between the existing and parallel metaverses. This step may be performed by a parallel instance maintenance layer.

Step 607: Data from the existing metaverse is fetched and shared with the parallel metaverse. This step may be performed by a data sharing interface or layer.

Step 608: Data received from the existing metaverse in the form of NFTs are decrypted. This step may be performed by a data deciphering interface or layer.

Step 609: The avatars are requested to provide their NFT and credit history.

Step 610: The authenticity and intactness of the provided NFTs is verified. This step may be performed by an NFT validator.

Step 611: The avatars may be optionally required to present NFTs from past transactions and/or confidence awards from other avatars. In some embodiments, this step may be performed by the token stacker.

Step 612: The source(s) of information from which NFTs were received is/are validated. This step may be performed by an NFT validator.

Step 613: Credit history information is retrieved. This step may be performed by a payer credit history controller or layer.

Step 614: The payment decision is transmitted. This step may be performed by a payment decision interface or layer.

As will be appreciated by one of ordinary skill in the art, the present invention may be embodied as an apparatus (including, for example, a system, a machine, a device, a computer program product, and/or the like), as a method (including, for example, a process, a computer-implemented process, and/or the like), or as any combination of the foregoing. Accordingly, embodiments may take the form of an entirely software embodiment (including firmware, resident software, micro-code, and the like), an entirely hardware embodiment, or an embodiment combining software and hardware aspects that may generally be referred to herein as a “system.” Furthermore, embodiments may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the described systems is implemented, the computer device and application-specific circuits associated therewith are deemed specialized computer devices capable of improving technology associated with intelligently controlling data transfers between network connected devices and a platform layer application server.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random-access memory (RAM), a read-only memory (ROM), an erasable programmable read-only memory (EPROM or Flash memory), a compact disc read-only memory (CD-ROM), and/or some other tangible optical and/or magnetic storage device. In other embodiments, however, the computer-readable medium may be transitory, such as a propagation signal including computer-executable program code portions embodied therein.

It will also be understood that one or more computer-executable program code portions may be required on a specialized computer for carrying out the specialized operations, including object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for intelligently controlling data transfers between network connected devices and a platform layer application server, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, apparatus, and computer program products for parallel metaverse-based systems are provided. Persons skilled in the art will appreciate that the present invention can be practiced by other than the described embodiments, which are presented for purposes of illustration rather than of limitation.

What is claimed is:

1. A method of transferring an asset from a first user of an existing metaverse to a second user of the existing metaverse, the method comprising:
detecting a suspicious characteristic;
when the suspicious characteristic is detected, suspending the transfer and creating a parallel metaverse, wherein:
the parallel metaverse comprises an interface enabling the first and second users to interact with the parallel metaverse;
at least one of the first and second users has authority to request the transfer in the parallel metaverse; and
neither of the first and second users has authority to approve the transfer in the parallel metaverse;
receiving an encrypted non-fungible token (NFT) from the existing metaverse in connection with the first and second users or the transfer;
decrypting the encrypted NFTs;
receiving a determination of whether to approve the transfer, wherein a party other than the first and second users determines whether to approve the transfer; and
when the transfer is approved, transferring the asset from the first user to the second user.

2. The method of claim 1, wherein the suspicious characteristic is a characteristic of the first user or the second user.

3. The method of claim 1, wherein the parallel metaverse remains functional whenever the existing metaverse is functional.

4. The method of claim 1, wherein the existing metaverse and parallel metaverse are connected to one another via a network layer.

5. The method of claim 1, further comprising requesting an additional NFT from a past transaction wherein the first or second user participated.

6. The method of claim 1, further comprising requesting, from one or more other users, a confidence award for the first or second user, wherein the transfer is approved by the party only when the confidence award is obtained.

7. The method of claim 1, further comprising requesting credit history of the first or second user.

8. The method of claim 1, wherein the party is a financial institution.

9. A system, comprising:
a parallel metaverse creator layer;
a parallel metaverse verifier layer;
a data sharing interface;
a data deciphering interface;
an NFT stacker;
an NFT validator;
a payment decision interface; and
a payment initiator interface.

10. The system of claim 9, the system further comprising a sender bank integrator.

11. The system of claim 9, the system further comprising a receiver bank integrator.

12. The system of claim 9, the system further comprising a payer credit history controller.

13. The system of claim 12, wherein the payer credit history controller is configured to request an NFT from a past transaction wherein the first or second user participated and/or a confidence award from one or more other users.

14. The system of claim 9, the system further comprising a role assignment interface.

15. The system of claim 9, the system further comprising a parallel instance maintenance layer.

16. A method of preventing a fraudulent transfer of an asset from a first user to a second user in an existing metaverse, the method comprising
detecting an unusual transactional pattern;
when the unusual transactional pattern is detected, suspending the transfer and creating a parallel metaverse, wherein:
the parallel metaverse comprises an interface enabling the first and second users to interact with the parallel metaverse;
at least one of the first and second users has authority to request the transfer in the parallel metaverse; and
neither of the first and second users has authority to approve the transfer in the parallel metaverse;
receiving an encrypted non-fungible token (NFT) from the existing metaverse in connection with the first and second users or the transfer, wherein the NFT is a cryptographic token that represents the asset;
decrypting the encrypted NFT; and
receiving a determination whether to approve the transfer, wherein a party other than the first and second users decides whether to approve the transfer, and wherein the determination is at least partially based on additional verification of the first or second avatar.

17. The method of claim 16, further comprising requesting an additional NFT from a past transaction wherein the first or second user participated.

18. The method of claim 16, further comprising requesting, from one or more other users, a confidence award for the first or second user.

19. The method of claim 16, further comprising requesting a credit history of the first or second user.

20. The method of claim 19, wherein the credit history is requested from a financial institution.
